(19) United States
(12) Patent Application Publication
(10) Pub. No.: US 2009/0254414 A1
(43) Pub. Date: Oct. 8, 2009

(54) METHOD AND SYSTEM FOR MANAGING ADVERTISEMENT QUALITY OF SPONSORED ADVERTISEMENTS

(76) Inventors: Michael Schwarz, Berkeley, CA (US); Zoe Abrams, Kensington, CA (US)

Correspondence Address: MPG, LLP AND YAHOO! INC., 710 LAKEWAY DRIVE, SUITE 200, SUNNYVALE, CA, 94085, US

(21) Appl. No.: 12/099,039

(22) Filed: Apr. 7, 2008

(51) Int. Cl. G06Q 30/00; G06Q 10/00; G06F 17/30

(52) U.S. Cl. 705/10; 705/14; 705/26

(57) ABSTRACT

Various embodiments of systems and methods for auctioning sponsored ads are provided. The auctioning systems and methods take hidden costs of sponsored ads into account. A user's future propensity to click on ads is influenced by his/her experience with past clicks. An ad with disappointing quality of landing page imposes a negative externality on the search engine and the future stream of revenue from a user is reduced. The externality may also be positive. A good experience with an ad may train users to pay more attention to other ads. The externality of an advertisement (ad) can be considered as a “hidden cost.” Including hidden costs of sponsored ads in the auctioning process promote (or encourage) ads with good quality and discourage (or penalize) ads with poor quality. By doing so, advertisers are likely to improve the quality of ads being placed in the bidding pool, which will result in improvement in the overall quality of sponsored ads. Users benefit from the higher quality ads. The advertisers also benefit from the higher quality ads by paying less or no hidden costs for ads and by getting more satisfied customers. The search engine (site) can also benefit from having higher quality sponsored ads to gain more ad revenue.

### BACKGROUND OF THE INVENTION

1. Field of the Invention

This invention relates generally to displaying of sponsored advertisements (ads) in search result pages, and more particularly, using hidden cost in the bidding of sponsored ads to improve advertisement quality of sponsored ads.

2. Description of the Related Art

Search engines have become indispensable to interacting on the web. In addition to processing information requests, they are navigational tools that can direct users to specific web sites or aid in browsing. Search engines can also facilitate e-commerce transactions as well as provide access to non-commercial services such as maps, online auctions, and driving directions. Typically, users of search engines enter search queries in the form of a search keyword, which can be a word or a phase, to satisfy the users' information needs. A search query can be in the form of a search keyword, which is a word or a phrase such as “auto”, or a sentence, such as “help me find an auto.” If the search query is in the form of a sentence, the search engine can parse the sentence to find the keyword in the sentence, such as “auto” in the search sentence “help me find an auto.”

After a search engine receives a search query from a user, the search engine returns a search result page, which can contain links to additional search result pages. The search result page(s) contains search results corresponding to the search query (or search keyword). Often, the search result page also contains sponsored ads that correspond to the search query. Sponsored ads are paid by advertisers to appear along with the search results.

Sponsored ads uniquely combine inputs from advertisers, web search engines and users. Advertisers, who can be content providers or representatives from ad agencies, select search keywords they believe will best link user queries to their web sites. A web search engine matches a searcher's query to the keywords selected by the advertisers and displays the corresponding sponsored links (or sponsored ads). In most cases, advertisers whose ads are displayed in the search result page(s) pay the search engine when the user clicks on their sponsored ads. This type of payment is called pay per click.

The quality (or clickability) of sponsored ads vary. It is in this context that embodiments of the present invention arise.

### SUMMARY OF THE INVENTION

Various embodiments of systems and methods for auctioning sponsored ads are provided. The auctioning systems and methods take hidden costs of sponsored ads into account. A user's future propensity to click on an ad is influenced by his/her experience with past clicks. An ad with a disappointing quality landing page imposes a negative externality on the search engine, and the future stream of revenue from a user is reduced. The externality may also be positive. A good experience with an ad may train users to pay more attention to other ads. The externality of an advertisement (ad) can be considered a “hidden cost.” Including hidden costs of sponsored ads in the auctioning process promote (or encourage) ads with good quality and discourage (or penalize) ads with poor quality. By encouraging good ads and discouraging bad ads, advertisers are likely to improve the quality of ads being placed in the bidding pool, which will result in improvement in the overall quality of sponsored ads. Users can benefit from the higher quality ads. The advertisers can also benefit from the higher quality ads by paying less for good ads (in some cases making gains) and by getting more satisfied customers. The search engine (site) can also benefit from having higher quality sponsored ads. By improving the quality of sponsored ads, search engine can gain more revenue, since satisfied customers are more likely to click on sponsored ads in the future.

It should be appreciated that the present invention can be implemented in numerous ways, including as a method, a system, or a device. Several inventive embodiments of the present invention are described below.

In accordance with one embodiment, a method of auctioning sponsored ads displayed in search result pages by taking hidden costs of sponsored ads into consideration is provided. The method includes receiving sponsored ads and keywords corresponding to sponsored ads from advertisers, and assigning a hidden cost to each sponsored ad received. The method also includes receiving bids for the sponsored ads that were received, and receiving a search query with a search keyword from a search user. The method further includes identifying sponsored ads having received bids and corresponding to the search keyword. In addition, the method includes determining an order of display and payment of each sponsored ad corresponding to the search keyword by using an auction method that incorporates the hidden costs assigned to the sponsored ads. Additionally, the method includes displaying sponsored ads in search result pages generated for the search keyword in the determined order of display.

In another embodiment, a method of auctioning sponsored ads displayed in search result pages by taking hidden costs of sponsored ads into consideration is provided. The method includes receiving sponsored ads and keywords corresponding to sponsored ads from advertisers, and assigning a hidden cost to each sponsored ad received. The method also includes receiving bids for the sponsored ads that were received, and receiving a search query with a search keyword from a search user. The method further includes identifying sponsored ads having received bids and corresponding to the search keyword. In addition, the method includes determining an order of display and payment of each sponsored ad corresponding to the search keyword by using an auction method that incorporates the hidden costs assigned to the sponsored ads. The auction method is a generalized second pricing (GSP) method and the hidden costs of sponsored ads are subtracted from the bids of sponsored ads before the GSP method to determine the order of display for sponsored ads corresponding to the search keyword and to determine the second-price payment of sponsored ads by the GSP method. The hidden costs are added to the second-price payment of sponsored ads to reach the payment for sponsored ads corresponding to the search keyword. Additionally, the method includes displaying sponsored ads in search result pages generated for the search keyword in the determined order of display.

In another embodiment, a system for providing sponsored ads displayed in search result pages by taking hidden costs of sponsored ads into consideration is provided. The system includes a search engine system to receive search keywords from users and to provide search result pages corresponding to the search keywords to the users who enter the search keywords. The system also includes a sponsored ads system for providing sponsored ads displayed in search result pages. The sponsored ads system uses an auction method of search keywords entered by users. The auction method incorporates the hidden costs of sponsored ads. The sponsored ads system is in communication with the search engine system. The system further includes a user system allowing a user to enter a search query with a search keyword to the search engine system. In addition, the system includes a system of an advertiser for the advertiser to enter bids of sponsored ads to the sponsored ads system.

In another embodiment, a sponsored ads system for providing sponsored ads displayed in search result pages by taking hidden costs of sponsored ads into consideration. The sponsored ads system includes a sponsored ads auction system, which includes an auction component, a hidden cost storage, and a bid storage. The auction component is configured to perform auctioning of the search keyword entered by the user for bids for sponsored ads corresponding to the search keyword, the hidden cost storage stores hidden costs of sponsored ads. The bid storage stores the bids of sponsored ads, and the auction component computes an order of display in the search result pages and payment of the sponsored ads corresponding to the search keyword based on bids and hidden costs of the sponsored ads. The sponsored ads system also include a sponsored ads server storing information of sponsored ads including links to sponsored ads and display information of sponsored ads. The sponsored ads server provides the information of sponsored ads to be displayed in the search result pages.

In yet another embodiment, a sponsored ads auction system for auctioning sponsored ads displayed in search result pages by taking hidden costs of sponsored ads into consideration is provided. The sponsored ads auction system includes an auction component, wherein the auction component is configured to perform auctioning of the search keywords for bids for sponsored ads corresponding to the search keywords. The sponsored ads auction system also includes a hidden cost storage for storing the hidden costs of sponsored ads. The sponsored ads auction system further includes a bid storage for storing the bids of sponsored ads. The auction component computes orders of display in search result pages and payment of the sponsored ads corresponding to the search keywords based on bids and hidden costs of the sponsored ads based on an auction method that incorporates the hidden costs of sponsored ads. The sponsored ads system is coupled to a search engine which receives search keywords and prepares the search result pages corresponding to the search keywords entered by users.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1A shows a search result page with sponsored ads, in accordance with one embodiment of the present invention.

FIG. 1B shows a landing page for a sponsored ad, in accordance with one embodiment of the present invention.

FIG. 2 shows a graph of costs and values of sponsored ads of an advertiser, in accordance with one embodiment of the present invention.

FIG. 3A shows a bid table of ads bidding to be displayed in the sponsored ads field, in accordance with one embodiment of the present invention.

FIG. 3B shows a bid table for sponsored ads, in accordance with another embodiment of the present invention.

FIG. 3C shows a table comparing the payment needed for each ad between the conventional GSP method and the GSP method with hidden cost, in accordance with one embodiment of the present invention.

FIG. 4A shows a method 400 of auctioning (or bidding for) a keyword of sponsored ads to display sponsored ads in a search result page, in accordance with one embodiment of the present invention.

FIG. 4B shows a search system, in accordance with one embodiment of the present invention.

FIG. 4C shows a table in the Bid Storage, in accordance with one embodiment of the present invention.

FIG. 4D shows a table of hidden cost stored in the Hidden Cost Storage, in accordance with one embodiment of the present invention.

FIG. 4E shows a curve of hidden cost of an ad, changing with time, in accordance with one embodiment of the present invention.

FIG. 4F shows a displayed sponsored ad, in accordance with one embodiment of the present invention.

FIG. 4G shows a modified GSP operation, in accordance with one embodiment of the present invention.

FIG. 5 shows a process flow of selecting and displaying sponsored ads in a search result page, in accordance with one embodiment of the present invention.

### DETAILED DESCRIPTION

As mentioned above, the quality (or clickability) of sponsored ads varies. A user's future propensity to click on ads is influenced by his/her experience with past clicks. The quality of ads can therefore affect the revenue from sponsored ads shown by a search engine.

An ad with disappointing quality landing page can impose a negative externality on the search engine, and can reduce the future stream of revenue from users. The externality may also be positive. A good experience with an ad may train users to pay more attention to other ads. The externality of an advertisement (ad) can be considered a “hidden cost.” Including hidden costs of sponsored ads in the auctioning process promote (or encourage) ads with good quality and discourage (or penalize) ads with poor quality. By encouraging good ads and discouraging bad ads, advertisers are likely to improve the quality of ads being placed in the bidding pool, which will result in improvement in the overall quality of sponsored ads. Users can benefit from the higher quality ads. The advertisers can also benefit from the higher quality ads by paying less for good ads (in some cases making gains) and by keeping customers satisfied. The search engine (site) can also benefit from having higher quality sponsored ads, since users of the search engine would be happier and become more loyal. Traffic to the search engine may also be increased due to more satisfied users.

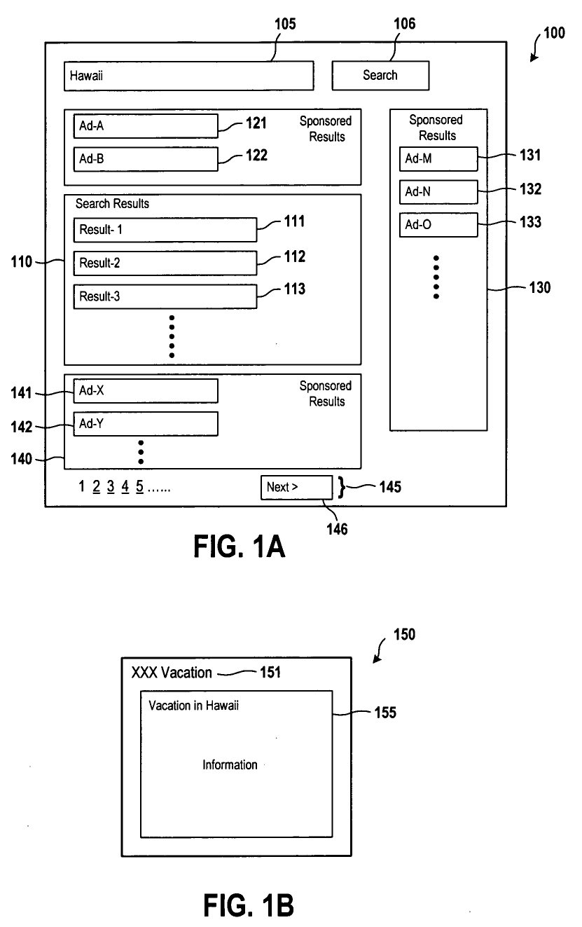

FIG. 1A shows a search result page 100 with sponsored ads, in accordance with one embodiment of the current invention. In page 100, there is search keyword, which can be a word or a phrase, entering box 105 and a search button 106. Search keyword entering box 150 allows a user to enter new search keyword and list the keyword entered, which in this case is “Hawaii,” to retrieve the search results in result field 110. The search button 106, when pushed, allows the user to initiate the search process. The search results for the keyword “hawaii” are shown in field 110, which includes a number of search results, such as Result-1 111, Result-2 112, and Result-3 113. Search results, such as Result-1 111, Result-2 112, and Result-3 113, contain information, such as links to web sites and brief descriptions of the web sites, that allow users to decide whether to access and to access the web sites. A number of search results, such as 10 to 12 search results, fill the field 110. If the number of search results retrieved by the search engine exceeds the number allowed on a search result page 100, there is an additional page field 145 near the bottom of page 100. In field 145, there are page numbers, such as 1, 2, 3 . . . , that allow the user to access (by clicking) a selected page directly, and a next button 146, which allows the user to access next search page. In the search result page 100 is not a first page, there could be a “previous” button (not shown) in field 145 that allows the user to access a previous search result page.

Sponsored advertisements (ads) often appear along with the search results. In FIG. 1A, sponsored ads, which are described as “Sponsored Results”, appear in three fields, 120, 130, and 140. In some embodiments, there is only one sponsored ad field, such as field 120, 130, or 140, not three fields at the same time, appearing on the search result page 100. Other numbers of sponsored ad fields or locations are also possible. In the example shown in FIG. 1A, sponsored ad field 120 is above the search results field 110, which is a very prominent position. Users often pay most attention to contents in the fields near the top of a web page. In field 120, there are a number of sponsored ads, such as Ad-A 121, and Ad-B 122. Field 130 is next to the search results field 110 and is also very visible. In field 130, there are a number of sponsored ads, including Ad-M 131 at top position, Ad-N 132 at second position, and Ad-O 133 on third position. Field 140 for sponsored ads is at the bottom of page 100. In field 140, there are a number of sponsored ads, including Ad-X 141 and Ad-Y 142. Users often pay more attention to ads on the top of the ad fields, such as fields 120, 130, and 140. Using the ad field 130 as an example, Ad-M 131 is more likely to be clicked than Ad-O 133, which is further down the listing of the ads in comparison to Ad-M 131.

When a user clicks on a link in the sponsored ad, he/she is sent to a landing page of the advertiser's web site. A landing page is the page that appears when a user clicks on an advertisement or a link in the search result. FIG. 1B shows a landing page 150 for a sponsored ad, Ad-A 121, in accordance with one embodiment of the present invention. When a user clicks on Ad-A 121, the landing page 150 of Ad-A 121, appears. Landing page 150 is a web page of a vacation site, with name of the name of the vacation site “XXX Vacation” 151, and a field 155 with information related to vacationing in Hawaii. Advertiser for Ad-A 121 pays the search engine when the user clicks on Ad-A 121 for sending the user to its web page, hence the name—“pay-per-click” pricing.

The number of ads that the search engine can show to the user on the search result page 100 is limited. As mentioned above, different positions of the ad fields, such as field 120, 130, and 140, on the search results page 100 have different “real-estate” value for advertisers. An ad shown at the top of a page is more likely to be clicked than an ad shown at the bottom. Therefore, the search engine needs a system for allocating the positions to advertisers. Auction is one of the choices and the most popular choice. Currently, the mechanisms of auction most widely used by search engines are based on “generalized second-price” (GSP). Generalized second-price (GSP) is an auction mechanism. GSP is the dominant transaction in a large and rapidly growing industry. Both Google and Yahoo! have gained over billions of ad revenue from this mechanism.

Multiple advertisers might want to employ a search engine for the same search keyword, which can be a word or a phrase. In these cases, an electronic auction ranks the sponsored link, with the highest bidder generally getting the top most rank, the second-highest bidder getting the next rank, and so on. The more providers that want to display their links in response to a term or phrase, the higher the minimum and maximum bids.

In the simplest GSP auction, for a specific keyword, advertisers submit bids stating their maximum willingness to pay for a click. When a user enters a keyword, the user receives search results along with sponsored ads, which show in decreasing order of bids. The ad with the highest bid is displayed at the top; the ad with the next highest bid is displayed in the second position, and so on. Using the sponsored ad field 130 of FIG. 1A as an example, Ad-M 131 is bidden at a higher value than all other ads in field 130. If a user subsequently clicks on an ad in position I, such as Ad-M131 at the top position, that advertiser is charged by the search engine an amount equal to the next highest bid, i.e., the bid of an advertiser in position (I+1), such as Ad-M 132 at the second position.

With multiple positions available, the GSP generalizes the second-price auction. For GSP, each advertiser pays the next highest advertiser's bid. The advertisers' bids can be changed at any time. An advertiser's bid for a particular keyword will apply every time that keyword is entered by a search engine user, until the advertiser changes or withdraws the bid. For example, the advertiser with the highest bid on a given keyword at some instant is shown as the top ad to a user searching for that keyword at that instant. However, the order of the ads may be different next time a user searches for that keyword, because the bids for all ads associated with the keyword could have changed in the meantime.

In sponsored search, the behavior of users in the long run is endogenous. Users continue to click on advertisements only if on average the value that a user derives from clicking on ads exceeds the cost of time required to click and to evaluate the contents of the offer. Sometimes the value of a click to a user may be a large negative number (e.g. an unscrupulous advertiser may mislead an unsuspecting user to infect his computer with spyware).

A user's future propensity to click on ads is influenced by his/her experience with past clicks. In other words, an ad with disappointing quality of landing page imposes a negative externality on the search engine because the future stream of revenue from a user is reduced by some amount (because some of the future clicks are lost since a disappointed user may learn to ignore ads). Of course, the externality may also be positive. A good experience with an ad may train users to pay more attention to other ads. The externality can be considered as a “hidden cost.” Obviously, if an ad's hidden cost is greater than its bid, a search engine should not show the ad (because the revenue is that an ad can bring is smaller than the loss in future revenue from a user clicking on that ad).

A relevant example of “hidden cost” is the market for renting space at a shopping mall. That market has much in common with the virtual “real estate” allocated for ads on a search result page. The shopping mall owner, much like a search engine (or owner or administrator of a search engine), tends to allocate space to the stores that value it the most. Reputable stores draws in customer traffic to the shopping mall, thus imposing a long-term positive externality on the mall and other tenants on the mall. These externalities are very important for the shopping malls, as apparent from the contracts between stores and mall operators. The rent paid by premium brand stores may be a few times lower than the rent paid by less reputable tenants. This is because the shopping mall uses pricing to attract tenants that will impose a positive externality on the mall and other tenants by creating more traffic.

To foster efficiency and better user experience for users and to generate more traffic to the search engine, a search engine should encourage ads that give users a positive experience, because they make users more likely to click on other ads, thus enhancing the value of the virtual real estate offered by the search engine through displaying of sponsored ads.

The auctions for sponsored ads allocate space based on the advertiser's willingness to pay per click, which can be adjusted by the clickability, otherwise known as quality, of the ad. For example, the ads can be ranked based on the product of the bid per click and the probability the ad is clicked when it is seen. Currently, the auctions for sponsored ads do not explicitly take into the account of hidden cost.

This causes a large inefficiency. Poor-quality ads, which can decrease users desire in clicking on future ads, are not discouraged and good-quality ads, which provide users with good experience, are not encouraged. Users' satisfaction and/or dissatisfaction of sponsored ads have great impact on the profitability and reputation of both the search engine and the advertisers who sponsor the ads. If users have negative impression of the sponsored ads, the users are less likely to click on sponsored ads, which would reduce the traffic and profit of the search engine. For advertisers who sponsor ads to increase their visibility or to get business, it is also important to care about users' experience with sponsored ads. Users are interested in ads that have good quality, such as having good usability, truthful content, and delivering products and/or service as promised, etc. Users benefit from the content, products and/or services offered by sponsored ads with good quality. When users have good user experience on sponsored ads with good quality, users are more likely to click on other sponsored ads in the future. When this happens, the search engine and the advertising community benefit in general benefit. The users also benefit from the good user experience, either through absorbing relevant and useful information offered by the sponsored ads or through purchasing quality products and/or services from the advertising sites.

The embodiments of the present invention describe methods and systems that take hidden cost of sponsored ads into consideration to encourage ads with good quality and to discourage ads with poor quality. With the inclusion of hidden cost, the quality of sponsored ads can be improved. The experience of shopping malls is not transferable to the sponsored ads environment, because the rental agreement for shopping mall space are negotiated, while the space for sponsored ads is sold via auction due to the fluidity and high volume of small transactions in this market. The nature and volume of user traffic enables search engines to effectively measure the hidden cost of a sponsored ad.

As mentioned above, there is a hidden cost for each sponsored ad from the search engine's point of view. The hidden cost varies for each ad, depending how the extent of positive or negative experience the ad would affect on the users. When a sponsored ad has a good quality and can provide users with good experience, the hidden cost of that sponsored ad has a negative value. For such ads, the hidden cost is not cost anymore for the search engine, but has turned into a “hidden value” to the search engine. If a user feels very good about the ad and would like to use or view or sponsored ads in the future, the ad would have a high hidden value. In contrast, when a sponsored ad is of poor quality, the hidden cost can be very high if a user has a very bad experience, such as purchased product or service not being delivered as promised.

There are different ways for measuring the hidden costs of sponsored ads. For example, the search engine (or the business administrator of the search engine) can hire professionals to evaluate the quality of the sponsored site to determine a value of the hidden cost. Alternatively, the search engine can also track the viewing or clicking pattern of users of sponsored ads to find out if the users are interested in or are turned off by the sponsored ads they click or view earlier. Other ways of accessing a hidden cost for a web site are also possible.

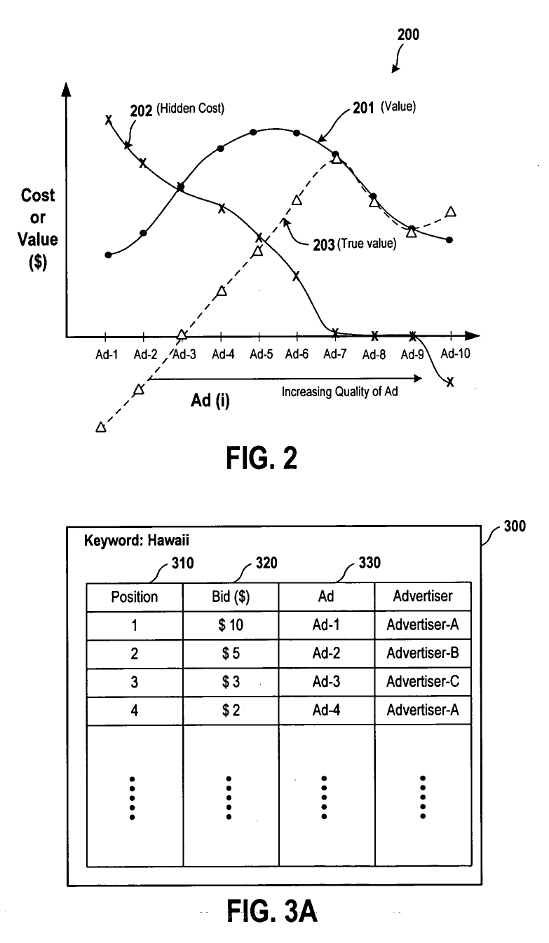

FIG. 2 shows a graph 200 of costs and values of sponsored ads of an advertiser-X, in accordance with one embodiment of the present invention. The x-axis of graph 200 is the quality of ad, with low quality on the left and high quality on the right. The y-axis of graph 200 is the values or costs of sponsored ads. In the example in FIG. 2, an advertiser, Advertiser-X, has N number of ads to bid for sponsor ads. The advertiser-X manages the advertising and bidding of 10 ads as sponsored ads for a particular keyword, such as “Hawaii”. Curve 201 shows the value (per click), V(i), of the sponsored ad, ad “i” where i is the number of ad in FIG. 2, to the advertiser (or the merchant behind the ad). In the example in FIG. 2, ads with low quality (or poor quality), such as Ad-1 and Ad-2, usually do not appeal to customers; therefore, the value (per click) of the ad is relatively low, compared to the other ads, to the advertiser. Ads with high quality, such as Ad-9 and Ad-10, might cost a lot to produce or might require advertiser-X (or the merchant) to offer a significant discount; therefore, the values of Ad-9 and Ad-10 are not the highest for advertiser-X. Curve 201 is only one example. Other shapes of curve 201 are also possible, depending on the mix of sponsored ads managed by advertiser-X.

Curve 202 is a curve of hidden cost, H(i), for the sponsored ad, ad “i” where i is the number of ad in FIG. 2, to the advertiser. The hidden cost of each sponsored ad is assigned by administrators of a search engine or an administrator of sponsored ads. The value of the hidden cost of each sponsored ad is made available to advertisers, such as advertiser-X in this example. The final payment collected by the search engine from the advertisers takes hidden costs into account (i.e. advertisers need to pay for the hidden costs of their ads if their ads are displayed). The hidden cost of an ad can be accessed by a number of methods, which are described earlier. Since the ads in x-axis are listed in increasing quality, the hidden cost, H(i), decreases with the number of ads, i, such as hidden costs of Ad-1 and Ad-2 are higher than hidden costs of Ad-9 and Ad-10. Curve 203 shows the true values of ads, TV(i), which can be obtained by subtracting the hidden costs of ads (data in Curve 202) from the values of the ads to the advertiser (or data in Curve 201). Equation (1) shows the relationship between the value, hidden cost, and true value of each ad to advertiser-X and to the search engine.

TV(i)=V(i)−H(i) (1)

For some ads, such as Ad-1, and Ad-2, the true values of these ads become negative (not profitable). Advertisers, such as advertiser-X, would be foolish to promote ads that are not profitable (or with negative true values) to them. In addition, administrator(s) of search engines could decide not to display sponsored ads with negative values, since these ads created negative values for the search engines. For ads with true values being positive, the advertiser, which is Advertiser-X, can put them in the bidding process to be displayed since they will generate profits for the advertiser (or the merchant).

For advertisers who have a number of ads in their hands, they will most likely avoid promoting poor-quality ads whose true values are negative to them. For advertisers who are merchants who promote only their own web sites, it also would not make sense for them to promote ads with negative true values. They can improve the quality of their ads to reduce the hidden costs of their ads to make their ads have positive true value. As a consequence, this mechanism of including a hidden cost to each sponsored ad discourages advertisers from promoting poor-quality ads.

In FIG. 2, some ads, such as Ad-7, Ad-8, and Ad-9, have “0” hidden costs. Ad-10, which is the ad with highest quality in FIG. 2, has a negative hidden cost, which means it adds value to the search engine. Search engine could even pay for such an ad, since it adds value to the search engine.

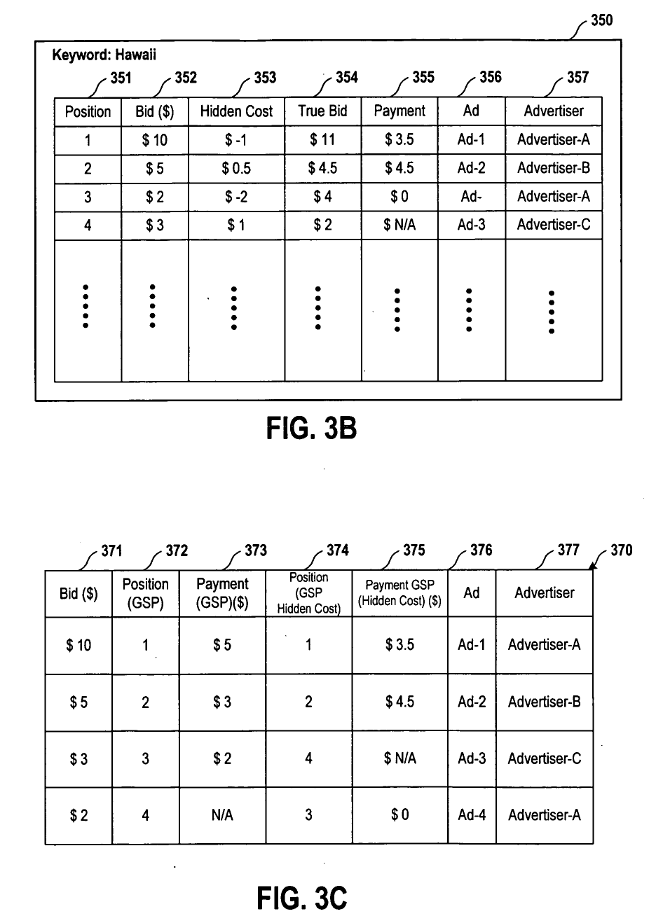

FIG. 3A shows a bid table 300 of ads bidding to be displayed in the sponsored ads field, such as field 130, of a search result page, in accordance with one embodiment of the present invention. As described above, the search keyword in FIG. 1A is “hawaii”. A number of advertisers, such as Advertiser-A, Advertiser-B, and Advertiser-C, with a number of ads, such as Ad-1, Ad-2, Ad-3, and Ad-4, bid for the “hawaii” keyword. In the bid table 300, there are a number of columns including “Position” column 310, “Bid” column 320, “Ad” column 330, and “Advertiser” column 340. In the example shown in FIG. 3A, Advertiser-A bids $10 for Ad-1 and receives the top position (or number 1 position). Advertiser-B bids $5 for Ad-2 and receives the second position. Advertiser-C bids $3 for Ad-3 and receives the third position. Advertiser-A bids $2 for Ad-4 and receives the fourth position. More advertisers with more ads can bid for the keyword “hawaii.”

According to GSP auction, Advertiser-A would pay $5 (the next bidding price) for Ad-1 to appear in the top position (or the position for Ad-M 131 of FIG. 1A) of sponsored-ad-displaying field 130 on FIG. 1A. Advertiser-B would pay $3 (the next bidding price) for Ad-2 to appear in the second position (or the position for Ad-N 132 of FIG. 1A) of sponsored-ad-displaying field 130 on FIG. 1A.

FIG. 3B shows a bid table 350 for sponsored ads, in accordance with one embodiment of the present invention. In bid table 350, the hidden cost is taken into account. Similar to bid table 300, a number of advertisers, such as Advertiser-A, Advertiser-B, and Advertiser-C, with a number of ads, such as Ad-1, Ad-2, Ad-3, and Ad-4, bid for the “hawaii” keyword. In the bid table 350, there are a number of columns including “Position” column 351, “Bid” column 352, “Hidden Cost” column 353, “True Bid” column 354, “Payment” column 355, “Ad” column 356, and “Advertiser” column 357. As in the example shown in FIG. 3A, Advertiser-A bids $10 for Ad-1, Advertiser-B bids $5 for Ad-2, Advertiser-C bids $3 for Ad-3, and Advertiser-A bids $2 for Ad-4. However, Ad-1 has a hidden cost of $-1 (or a hidden value of $1 to the search engine), Ad-2 has hidden cost of $0.5, Ad-3 has a hidden cost of $-2, and Ad-4 has a hidden cost of $1. With the hidden cost added, the true bid value for each ad appears in column 354. The true bid value is $11 is for Ad-1, $4.5 for Ad-2, $4 for Ad-4, and $2 for Ad-3. The true bid value reflects the true bid value of each ad to the search engine and is obtained by subtracting hidden cost from the bid amount. For ads with negative hidden cost (or with hidden value), the true bid value becomes higher than the bid amount. In contrast, for ads with positive hidden cost, the true bid value becomes lower than the bid amount. The true bid value appears in column 354 is used to determine the position of the ads appearing in the sponsored ad displaying field, such as field 130 of FIG. 1A. Due to the inclusion of hidden cost, the position of Ad-4 becomes above Ad-3 (or from number 4 position in FIG. 3A to number 3 position to FIG. 3B).

In the GSP method without including the hidden cost, the bidders pay the amounts bid for the next position. However, in the GSP method with hidden cost taken into consideration, the payment also needs to take the hidden cost into consideration. For example, Advertiser-A should pay $3.5 for Ad-1, which is the true bid value of Ad-2 ($4.5) plus the hidden cost of Ad-1 ($-1). Displaying Ad-1 involves a hidden cost of ($-1) and this hidden cost needed to be added to the true bid value of next bid ($4.5). Based on the same method of calculation, Advertiser-B needs to pay $4.5 for displaying Ad-2 in the second position, and Advertiser-A needs to pay $0 (free) for displaying Ad-4 in the third position. The payment of amount for Ad-3 is not known, since it depends on the bid and hidden cost of an ad at position 5, which is not described.

FIG. 3C shows a table comparing the payment needed for each ad between the conventional GSP method and the GSP method with hidden cost, in accordance with one embodiment of the present invention. For Ad-1 to appear in the top position, the payment for the conventional GSP method is $5, while the payment for the method of GSP plus hidden cost is $3.5. The lowering is due to the negative hidden cost ($-1) of Ad-1 and the lowering of true bid value of Ad-2. The payment needed for Ad-2 to appear in the second position increases from $3 to $4.5, which is due to the positive hidden cost ($0.5) and the increase of true bid value of Ad-4 (as a result of relatively high hidden value of $2). As for Ad-4, due to the high value of the negative hidden cost ($-2), or hidden value of $2, Ad-4's display position is moved from 4^{th} to 3^{rd}. Additionally, Advertiser-A does not need to pay for displaying Ad-4 (payment of $0). This is a result of the high value of the negative hidden cost ($-2) of Ad-4 and lowering of true bid value of Ad-3 by its positive hidden cost.

Advertisers with ads having negative hidden costs, such as Advertiser-A with Ad-1 and Ad-4, are rewarded with lower payment. Advertisers with ads having positive hidden cost, such as Advertiser-B with Ad-2 or Advertiser-C with Ad-3, need to either pay higher payment, such as increasing from $3 to $4.5 for Ad-2, or receive lower display location, such as Ad-3 from 3^{rd} position to 4^{th} position.

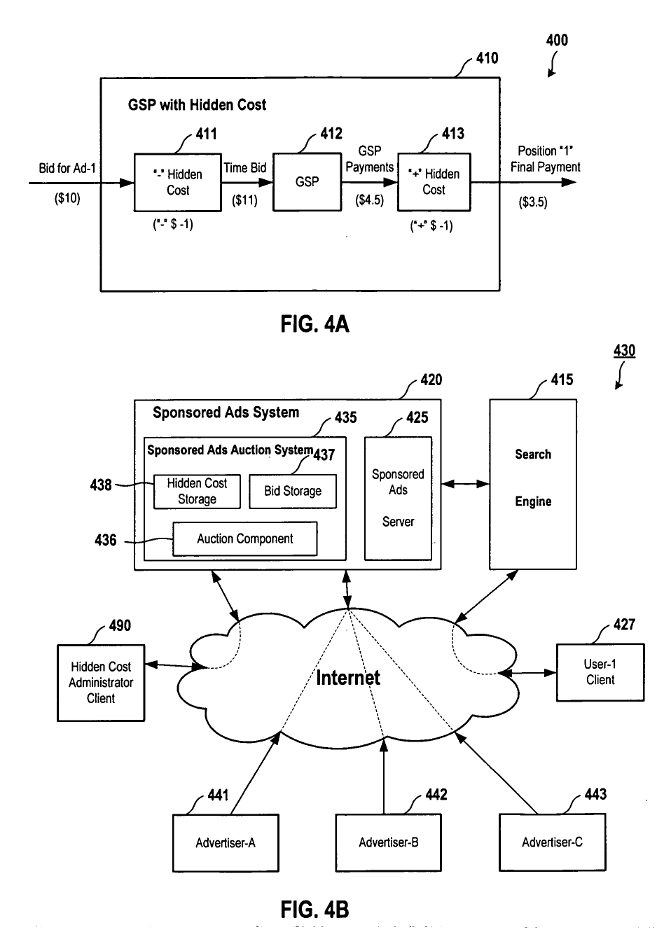

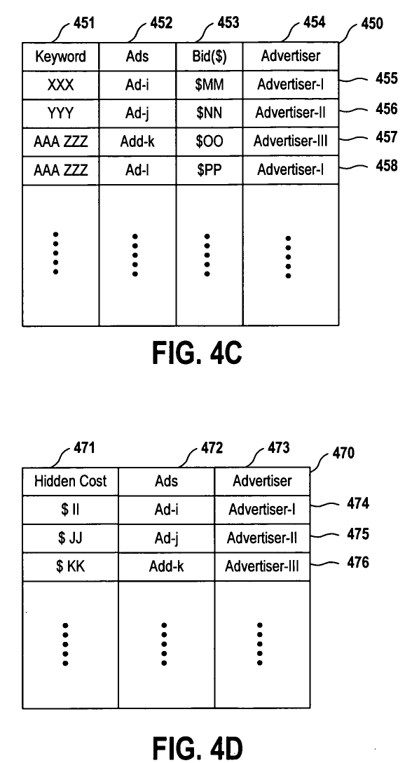

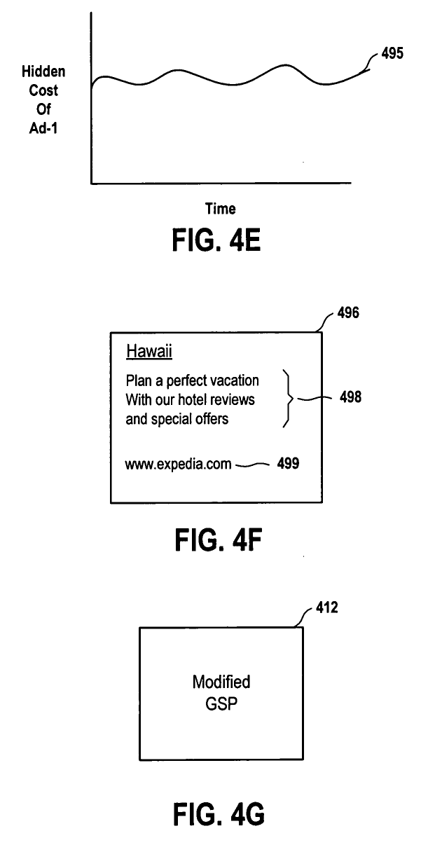

FIG. 4A shows a method 400 of auctioning (or bidding for) a keyword of sponsored ads to display sponsored ads in a search result page, in accordance with one embodiment of the present invention. In method 400, a bid for an Ad-1 is entered into a system 410, which stores the hidden cost of Ad-1 and a GSP operation (or method) 412. The bid of Ad-1 goes through operation 411 of subtracting hidden cost to arrive at the “true bid of Ad-1”. The “true bid of Ad-1” goes through the GSP operation 412, which calculate the payment (or GSP payment) for Ad-1 based on GSP. The GSP payment goes through operation 413 of adding back the hidden cost of Ad-1 to arrive at the final payment and display location of Ad-1 for the method employing GSP plus hidden cost.

FIG. 4B shows a search system 430 including a Search Engine 415, in accordance with one embodiment of the present invention. Search system 430 includes a Sponsored Ads System 420, which provides sponsored ads to appear along with the search results generated by the Search Engine 415. The search system 430 further includes a Sponsored Ads Auction System 435. The Sponsored Ads Auction System 435 is in communication with systems of advertisers, such as system 441 of Advertiser-A, system 442 of Advertiser-B, . . . , and system 443 of Advertiser-N. N can be any number. System 435 is in communication with systems of advertisers through Internet 440, as shown in FIG. 4B. Alternatively, the systems of advertisers can be in direct communication with the Sponsored Ads Bidding System 435 without going through Internet 440. Advertisers use systems, such as 441, 442, and 443, to enter bids for advertisements. Advertisers can also see the hidden cost associated with each ad.

The Sponsored Ads Auction System 435 has an Auction Component 436, such as a processor configured to perform GSP auction or other types of auction. Other types of auction, such as VCG (Vickrey-Clarke-Groves) auction can also be used. The examples and discussion so far are based on GSP auction. However, the concept of applying hidden cost in the auction process can also apply to other types of auction. In addition to the Auction Component 436, there are a Hidden Cost storage 438, which stores the hidden cost for all ads, and a Bid Storage 437, which stores the bids for ads. FIG. 4C shows an exemplary table 450 in the Bid Storage 437, in accordance with one embodiment of the present invention. Table 450 contains a column of keyword 451, which is the search keyword being bidden (or auctioned), a column of ads 452, and a column of bid 453 for an ad with corresponding keyword in the same row. Table 450 also contains a column of advertisers 454. In Table 450, there are a number of rows, such as rows 455, 456, 457, and 458. An ad, such as Ad-1, can be associated with more one keyword, such as keyword “XXX” and “AAA ZZZ”. Different bid amounts, such as amount $MM and $PP can be associate with an ad for different keyword. Alternatively, same bid amount can be placed for an ad for different keyword.

FIG. 4D shows a table 470 of hidden cost stored in the Hidden Cost Storage 438, in accordance with one embodiment of the present invention. Table 470 has a column of Hidden Cost 471, a column of Ads 472, a column of Advertisers 473. Rows, such as 474, 475, and 476, contains bidden cost with associated ads and advertisers. Auction Component 436 stores algorithm (or method) for calculating payment needed for auctioning a spot on the sponsored ad displaying field, such as field 130. The algorithm in Auction Component 436 is shown in FIG. 4A. Advertisers enter bids for ads and bidding keyword into the system 435 to be stored in the Bid Storage 437.

System 430 also includes a client of Hidden Cost Administrator 490, which allows the hidden cost administrator to enter hidden cost for each ad. As mentioned above, search engine administrator can use various methods to assign a hidden cost to an ad. The hidden cost of an ad can vary with time. The content of an ad can vary with time; therefore the hidden cost of the ad can vary with time. In addition, users' perception of an ad might change with time. FIG. 4E shows a curve 495 of hidden cost of an ad, Ad-1, changing with time, in accordance with one embodiment of the present invention. Search engine administrator(s) uses the system of Search Engine Administrator 490 to update the hidden cost for each ad stored in the Hidden Cost Storage 438.

The sponsored ad system 420 further includes a sponsored ads server 425, which stores information of sponsored ads, such as the links to ads, and display information of sponsored ads. Alternatively, the sponsored ads server 425 is included in sponsored ads auction system 435. The display information of sponsored ads stored in the sponsored ads server 425 can include descriptions of the ads that appear in the sponsored ads fields, such as fields 120, 130, and 140, of a search result page, such as page 100, and the style of the how the sponsored ad would be displayed. FIG. 4F shows an example of a displayed sponsored ad 496 that would appear in a sponsored-ad displayed field, such as field 130, of a search result page, such as page 100. The displayed sponsored ad 496 include a link “Hawaii” 497, a brief description 498 of the link “Hawaii” 497, and the name of the web site 499 (in this case www. Expedia.com), which provides the sponsored ad. The link “Hawaii” is bolded and the color of web site 499 is in green color. The information related to displaying the sponsored ads is stored in the sponsored ads server 425.

The search system 430 includes a client 427 of User-1 allowing User-1 to enter a search query (or search keyword) and to receive a search result page, which would include available sponsored ads. The Search Engine 415 is in communication with the Sponsored Ads System 420. When a user, such as User-1 submits a search query, or search keyword, to the Search Engine 415. The Search Engine 415 passes the keyword to the Sponsored Ads System 420, which determines and provides sponsored ads to be displayed along with the search results and the displaying order of the sponsored ads. The Auction Component 436 of the Sponsored Ad Bidding System 435, utilizing information stored in the Hidden Cost storage 438 and Bid Storage 437, computes the bids of sponsored ads that bid for the keyword to determine which sponsored ads, and in what order, are selected to be displayed. The Sponsored Ads system 420 returns the list of ads, the order of display, and the display information (retrieved from sponsored ad server 425) to the search engine 420. Search engine 420 then generates a search result page, such as page 100, and displays the generated page to User-1.

The methods and systems described above use advertisers' bids and hidden costs of sponsored ads to determine the order of sponsored ads to be displayed. Alternatively, other factors can influence the order of display as well. For example, the relevancy of sponsored ad can be added as a factor in determining the display order of sponsored ads. The sponsored-ads bidding system can give different weights to ads for a particular keyword based on their relevancy to the keyword. FIG. 4G shows a modified GSP operation 412′, which can be used in method 400 of FIG. 4A, in accordance with one embodiment of the present invention. In one embodiment, the modify GSP operation 412′ takes the relevancy of sponsored ads into account. The sponsored ads are weighted based on their relevancy to the search keyword. In one embodiment, the relevancy is determined by the descriptions of the sponsored ads against the keyword the ads are bidden. In another embodiment, the relevancy is determined by the contents in the landing pages of the sponsored ads against the keyword the ads are bidden.

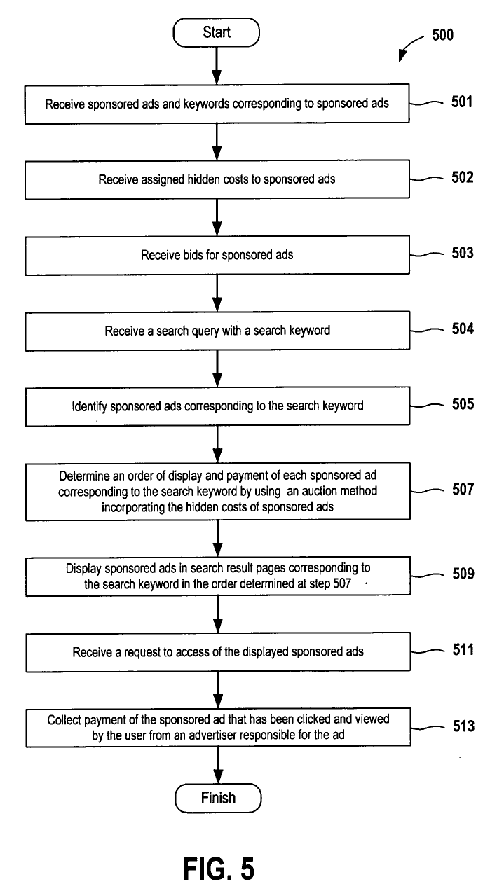

FIG. 5 shows a process flow 500 of selecting and displaying sponsored ads in a search result page, in accordance with one embodiment of the present invention. The process of selecting sponsored ads to display in a search result page is also called sponsored ads auction. At step 501, the sponsored ads system receives sponsored ads, and search keywords corresponding to sponsored ads from advertisers. At step 502, hidden costs administrator(s) assign a hidden cost to each sponsored ad received by the sponsored ads system. The administrator determines the hidden costs of bidden ads and enters the hidden cost information into the sponsored ads system. The hidden costs of sponsored ads are available to the advertisers when advertisers bid for sponsored ads. In one embodiment, some sponsored ads do not have hidden costs assigned. This could be due to the newness of the sponsored ads to the sponsored ads system and the administrator(s) does not have time to assign a hidden cost yet. Alternatively, the administrator(s) of sponsored ads system can configure the sponsored ads system to allow only the sponsored ads with assigned hidden costs to participate in the bidding (or auctioning) process. At step 503, sponsored ads system receives bids for sponsored ads, which are from multiple advertisers for multiple search keywords.

At step 504, the search engine receives a search query with search keyword from a user. The user enters a search query to initiate a search. As mentioned above, the search keyword can be a word or a phrase. At step 505, the sponsored ads that correspond to the search keyword entered by the user are identified by the system. The bids and hidden costs of ads identified are also determined. The information, such as sponsored ads, keywords, bids, and hidden costs, are stored in the sponsored ads system, and just needs to be retrieved. At step 507, the order of display and payment for each ad is determined by using an auction method taking hidden costs of sponsored ads into account (or incorporates hidden costs of sponsored ads). The payment of each ad takes hidden cost into account. In one embodiment, the auction method is GSP. In another method, the auction method is a modified GSP method, which takes relevancy of sponsored ads into consideration. The methods of determining the order and the payment amounts have been described earlier.

At step 509, the sponsored ads corresponding to the search keyword are displayed in the search result page(s) in an order determined in the step 507. The top few sponsored ads are displayed in the first search result page. The following few are displayed in the second search result pages, and so on. The number of ads displayed on each search result page is determined by availability of space for sponsored ads and availability of sponsored ads. For example, the sponsored ad field might limit 3 or 5 sponsored ads to be displayed. If there are a number of fields, such as fields 120, 130, and 140 of FIG. 1A, the sponsored ad system has an algorithm to determine which ads are displayed in which field. Alternatively, fields 120, 130, and 140 are considered as one single field. The top few sponsored ads in the order are displayed in field 120. The next few in the order are displayed in field 130, and a few sponsored ads in the order after the ones displayed in field 130 are displayed in field 140. In another embodiment, fields 120, 130, and 140 are auctioned separately.

The availability of sponsored ads is also a factor. Some search keywords might have fewer number of ads bidding for display than number of spots to display available. Some search keyword might not even receive any sponsored ad bidding for the keyword. In this case, no sponsored ads are displayed. At step 511, the search engine receives a request from the user to access one of the sponsored ads. The user sees the displayed sponsored ads on one of the search result pages and clicks on one of the sponsored ads to view the content of the ad. When user clicks on a link of a sponsored ad, a landing page of the clicked link (or clicked ad) is presented to the user and is viewed by the user.

At step 513, the search engine (or operator of search engine) collects payment of the sponsored ad that has been clicked and viewed (or accessed) by the user from the advertiser responsible for the ad. The payment amount has been determined at step 507. The payment amount takes hidden cost of the ad into account. The user can click and view more than one sponsored ads. Each time the user clicks and views a sponsored ad, the search engine collects payment for the advertiser of the sponsored ad being clicked and viewed.

The sponsored ads auction system and method with the inclusion of hidden cost in the auctioning process promote (or encourage) ads with good quality and discourage (or penalize) ads with poor quality by assigning a hidden cost to each sponsored ad. Hidden cost takes user's experience into account. By encouraging good ads and discouraging bad ads, advertisers are likely to improve the quality of ads being placed in the bidding pool, which will result in improvement in the overall quality of sponsored ads. Users can benefit from the higher quality ads. The advertisers can also benefit from the higher quality ads by paying less for good ads and by getting more satisfied customers. The search engine (site) can also benefit from having higher quality sponsored ads. By improving the quality of sponsored ads, search engine can gain more revenue, since satisfied customers are more likely to click on sponsored ads in the future.

The concept of the invention of including a hidden cost for ads is not limited to GSP bidding of sponsored ads of search. Hidden cost can also be included in other types of ad-bidding or auction, such as VCG auction. Ad-bidding or auction is also used in displaying ads in web sites by content matching. The concept of the current invention of assigning a hidden cost to each advertisement can be used in any ad-bidding or auctioning methods and systems.

With the above embodiments in mind, it should be understood that the invention might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of auctioning sponsored ads displayed in search result pages by taking hidden costs of sponsored ads into consideration, comprising:
receiving sponsored ads and keywords corresponding to sponsored ads from advertisers;
assigning a hidden cost to each sponsored ad received;
receiving bids for the sponsored ads that were received;
receiving a search query with a search keyword from a search user;
identifying sponsored ads having received bids and corresponding to the search keyword;
determining an order of display and payment of each sponsored ad corresponding to the search keyword by using an auction method that incorporates the hidden costs assigned to the sponsored ads; and
displaying sponsored ads in search result pages generated for the search keyword in the determined order of display.

2. The method of claim 1, further comprising:
receiving a request to access one of the displayed sponsored ad; and
collecting payment of the sponsored ad that has been accessed by the user from an advertiser responsible for the accessed sponsored ad.

3. The method of claim 1, wherein the hidden cost of each sponsored ad is assigned based on quality and user experience of the sponsored ad.

4. The method of claim 3, wherein quality and user experience of the sponsored ad is determined by a professional or by tracking users' viewing patterns of sponsored ads after viewing the sponsored ad.

5. The method of claim 1, wherein the hidden costs of sponsored ads change with time and are updated by an administrator.

6. The method of claim 1, wherein the auction method is a generalized second pricing (GSP) method that incorporates the hidden costs of sponsored ads.

7. The method of claim 6, wherein the hidden costs of sponsored ads are subtracted from the bids of sponsored ads before the GSP method to determine the order of display for sponsored ads corresponding to the search keyword and to determine the second-price payment of sponsored ads by the GSP method, and the hidden costs are added to the second-price payment of sponsored ads to reach the payment for sponsored ads corresponding to the search keyword.

8. The method of claim 1, wherein sponsored ads with good quality and providing good user experience have lower hidden cost than sponsored ads with poor quality and providing poor user experience.

9. The method of claim 1, wherein the hidden costs of sponsored ads can be negative for sponsored ads with good quality and providing good user experience.

10. A method of auctioning sponsored ads displayed in search result pages by taking hidden costs of sponsored ads into consideration, comprising:
receiving sponsored ads and keywords corresponding to sponsored ads from advertisers;
assigning a hidden cost to each sponsored ad received;
receiving bids for the sponsored ads that were received;
receiving a search query with a search keyword from a search user;
identifying sponsored ads having received bids and corresponding to the search keyword;
determining an order of display and payment of each sponsored ad corresponding to the search keyword by using an auction method that incorporates the hidden costs assigned to the sponsored ads, wherein the auction method is a generalized second pricing (GSP) method and the hidden costs of sponsored ads are subtracted from the bids of sponsored ads before the GSP method to determine the order of display for sponsored ads corresponding to the search keyword and to determine the second-price payment of sponsored ads by the GSP method, and wherein the hidden costs are added to the second-price payment of sponsored ads to reach the payment for sponsored ads corresponding to the search keyword; and
displaying sponsored ads in search result pages generated for the search keyword in the determined order of display.

11. A system for providing sponsored ads displayed in search result pages by taking hidden costs of sponsored ads into consideration, comprising:
a search engine system to receive search keywords from users and to provide search result pages corresponding to the search keywords to the users who enter the search keywords;
a sponsored ads system for providing sponsored ads displayed in search result pages, wherein the sponsored ads system uses an auction method of search keywords entered by users, wherein the auction method incorporates the hidden costs of sponsored ads, and wherein the sponsored ads system is in communication with the search engine system;
a user system allowing a user to enter a search query with a search keyword to the search engine system; and
a system of an advertiser for the advertiser to enter bids of sponsored ads to the sponsored ads system.

12. The system of claim 11, further comprising:
a system of an administrator for the administrator to enter hidden costs of sponsored ads.

13. The system of claim 11, wherein the sponsored ads system comprises:
a sponsored ads auction system, which includes an auction component, a hidden cost storage, and a bid storage, wherein the auction component is configured to perform auctioning of the search keyword entered by the user for bids for sponsored ads corresponding to the search keyword, the hidden cost storage stores hidden costs of sponsored ads, and the bid storage stores the bids of sponsored ads, and wherein the auction component computes an order of display in the search result pages and payment of the sponsored ads corresponding to the search keyword based on bids and hidden costs of the sponsored ads; and
a sponsored ads server storing information of sponsored ads including links to sponsored ads and display information of sponsored ads, wherein the sponsored ads server provides the information of sponsored ads to be displayed in the search result pages.

14. The system of claim 11, wherein the auction method is a generalized second pricing (GSP) method that incorporates the hidden costs of sponsored ads.

15. The system of claim 14, wherein the hidden costs of sponsored ads are subtracted from the bids of sponsored ads before the GSP method to determine the order of display for sponsored ads corresponding to the search keyword and to determine the second-price payment of sponsored ads by the CSP method, and the hidden costs are added to the second-price payment of sponsored ads to reach the payment for sponsored ads corresponding to the search keyword.

16. A sponsored ads system for providing sponsored ads displayed in search result pages by taking hidden costs of sponsored ads into consideration, comprising:
a sponsored ads auction system, which includes an auction component, a hidden cost storage, and a bid storage, wherein the auction component is configured to perform auctioning of the search keyword entered by the user for bids for sponsored ads corresponding to the search keyword, the hidden cost storage stores hidden costs of sponsored ads, and the bid storage stores the bids of sponsored ads, and wherein the auction component computes an order of display in the search result pages and payment of the sponsored ads corresponding to the search keyword based on bids and hidden costs of the sponsored ads; and
a sponsored ads server storing information of sponsored ads including links to sponsored ads and display information of sponsored ads, wherein the sponsored ads server provides the information of sponsored ads to be displayed in the search result pages.

17. The sponsored ads system of claim 16, wherein the auction method is a generalized second pricing (GSP) method that incorporates the hidden costs of sponsored ads, and wherein the hidden costs of sponsored ads are subtracted from the bids of sponsored ads before the GSP method to determine the order of display for sponsored ads corresponding to the search keyword and to determine the second-price payment of sponsored ads by the GSP method, and the hidden costs are added to the second-price payment of sponsored ads to reach the payment for sponsored ads corresponding to the search keyword.

18. A sponsored ads auction system for auctioning sponsored ads displayed in search result pages by taking hidden costs of sponsored ads into consideration, comprising:
an auction component, wherein the auction component is configured to perform auctioning of the search keywords for bids for sponsored ads corresponding to the search keywords;
a hidden cost storage for storing the hidden costs of sponsored ads; and
a bid storage for storing the bids of sponsored ads, wherein the auction component computes orders of display in search result pages and payment of the sponsored ads corresponding to the search keywords based on bids and hidden costs of the sponsored ads based on an auction method that incorporates the hidden costs of sponsored ads, and wherein the sponsored ads system is coupled to a search engine which receives search keywords and prepares the search result pages corresponding to the search keywords entered by users.

19. The sponsored ads auction system of claim 18, wherein the hidden costs of sponsored ads are subtracted from the bids of sponsored ads before the GSP method to determine the orders of display for sponsored ads corresponding to the search keywords and to determine the second-price payment of sponsored ads by the GSP method, and the hidden costs are added to the second-price payment of sponsored ads to reach the payment for sponsored ads corresponding to the search keywords.

20. The sponsored ads auction system of claim 18, wherein the hidden costs of sponsored ads are determined by professionals or by tracking users' viewing patterns of sponsored ads after viewing the sponsored ad.
